(19) United States
(12) Patent Application Publication
(10) Pub. No.: US 2026/0239388 A1
(43) Pub. Date: Aug. 13, 2026

(54) SIDELINK SYNCHRONIZATION SIGNAL BLOCK TRANSMISSION IN WIDEBAND SIDELINK COMMUNICATIONS

(71) Applicant: QUALCOMM Incorporated, San Diego, CA (US)

(72) Inventors: Chih-Hao LIU, San Diego, CA (US); Stelios STEFANATOS, San Diego, CA (US); Giovanni CHISCI, San Diego, CA (US); Jing SUN, San Diego, CA (US)

(21) Appl. No.: 19/156,623

(22) PCT Filed: Mar. 12, 2024
(86) PCT No.: PCT/US2024/019497

§ 371 Date: Aug. 14, 2025

(30) Foreign Application Priority Data
Mar. 31, 2023 (GR) 20230100273

(51) Int. Cl. H04W 72/25; H04L 5/00; H04W 74/0808

(52) U.S. Cl. CPC H04W 72/25; H04L 5/0098; H04W 74/0808

(57) ABSTRACT

Wireless communications systems, apparatuses, and methods are provided. A method of wireless communication performed by a first sidelink user equipment (UE) includes receiving, from a network unit, a configuration indicating a first absolute frequency associated with a first resource block set and a second absolute frequency associated with a second resource block set, and transmitting, to a second sidelink UE, at least one of one or more first sidelink synchronization signal blocks (S-SSBs) at the first absolute frequency or one or more second sidelink S-SSBs at the second absolute frequency.

### CROSS-REFERENCE TO A RELATED APPLICATION

The present application claims priority to and the benefit of Greek Application No. 20230100273, filed Mar. 31, 2023, the disclosure of which is referenced herein as if fully set forth below and for all applicable purposes.

### TECHNICAL FIELD

This application relates to wireless communication systems, and more particularly, to sidelink synchronization signal block transmission in wideband sidelink communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing may extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR may be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE) may include receiving, from a network unit, a configuration indicating a first absolute frequency associated with a first resource block set and a second absolute frequency associated with a second resource block set; and transmitting, to a second sidelink UE, at least one of: one or more first sidelink synchronization signal blocks (S-SSBs) at the first absolute frequency; or one or more second sidelink S-SSBs at the second absolute frequency.

In an additional aspect of the disclosure, a method of wireless communication performed by a first sidelink user equipment (UE) may include performing a listen before talk (LBT) procedure in a first resource block set and a second resource block set based on a transmit buffer status associated with the first sidelink UE; transmitting, to a second sidelink UE based on the LBT being successful, a first synchronization signal block (SSB) in the first resource block set; and transmitting, to the second sidelink UE based on the transmit buffer status associated with the first sidelink UE and the LBT being successful, a second SSB in the second resource block set.

In an additional aspect of the disclosure, a first sidelink user equipment (UE) may include a memory; a transceiver; and at least one processor coupled to the memory and the transceiver, wherein the first sidelink UE is configured receive, from a network unit, a configuration indicating a first absolute frequency associated with a first resource block set and a second absolute frequency associated with a second resource block set; and transmit, to a second sidelink UE, at least one of: one or more first synchronization signal blocks (S-SSBs) at the first absolute frequency; or one or more second S-SSBs at the second absolute frequency.

In an additional aspect of the disclosure, a first sidelink user equipment (UE) may include a memory; a transceiver; and at least one processor coupled to the memory and the transceiver, wherein the first sidelink UE is configured perform a listen before talk (LBT) procedure in a first resource block set and a second resource block set based on a transmit buffer status associated with the first sidelink UE; transmit, to a second sidelink UE based on the LBT being successful, a first synchronization signal block (S-SSB) in the first resource block set; and transmit, to the second sidelink UE based on the transmit buffer status associated with the first sidelink UE and the LBT being successful, a second S-SSB in the second resource block set.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention may include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances may be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates S-SSB resources in multiple RB sets according to some aspects of the present disclosure.

FIG. 4 illustrates multiple RB sets in a channel occupancy time according to some aspects of the present disclosure.

FIG. 5 is a signal flow diagram of a communication method according to some aspects of the present disclosure.

FIG. 6 is a signal flow diagram of a communication method according to some aspects of the present disclosure.

FIG. 7 is a block diagram of an exemplary user equipment (UE) according to some aspects of the present disclosure.

FIG. 8 is a block diagram of an exemplary network unit according to some aspects of the present disclosure.

FIG. 9 is a flow diagram of a communication method according to some aspects of the present disclosure.

FIG. 10 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1M nodes/km2), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km 2), extreme data rates (e.g., multi-Gbps rate, 100+Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U may also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%)

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs) , or one or more radio units (RUs) ). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

Various aspects relate generally to wireless communication and more particularly to signaling for dynamic waveform switching. Some aspects more specifically relate to a network unit signaling a user equipment (UE) to switch between a first waveform type and a second waveform type for uplink communications. In some examples, a network unit may transmit an indicator to the UE to enable switching between the waveform types. When waveform switching is enabled, the network unit may transmit DCI to the UE indicating which waveform type to use for uplink communications. In some examples, the size of the DCI may be the same size for the first waveform type and the second waveform type. As such, the UE may blind decode the DCI using a common DCI size for the first waveform type and the second waveform type. The DCI may further include scheduled resources for a physical uplink shared channel (PUSCH) communication associated with the UE. The UE may transmit PUSCH communications to the network unit via the scheduled resources using the indicated waveform type.

Additionally or alternatively, the UE may switch between the first waveform type and the second waveform type on a semi-static basis. In some examples, a network unit may transmit an indicator to the UE to enable switching between the waveform types. When waveform switching is enabled, the network unit may transmit non-uplink scheduling DCI and/or a MAC-CE communication to the UE indicating which waveform type to use for uplink communications. The network unit may subsequently transmit uplink scheduling DCI to the UE using a DCI size associated with the previously indicated waveform type. The DCI size associated with the first waveform type may be different from the DCI associated with the second waveform type. As such, the UE may blind decode the DCI based on the DCI size associated with the indicated waveform type. The UE may transmit PUSCH communications to the network unit via the scheduled resources using the indicated waveform type.

Particular aspects of the subject matter described in this disclosure may be implemented to realize one or more of the following potential advantages. In some examples, by implementing dynamic waveform switching according to embodiments of the present disclosure, the described techniques may be used to reduce computing resources, memory requirements, latency, and/or power consumption in the UE by blind decoding a DCI having a common size for the first and second waveform types as compared to blind decoding a first DCI associated with the first waveform type and blind decoding a second, different sized DCI associated with the second waveform type. The dynamic waveform switching according to embodiments of the present disclosure may increase network coverage and/or network capacity. For example, the UE may switch to transmitting uplink communications using a DFT-s-OFDM waveform to increase range and coverage. In some examples, the UE may switch to transmitting uplink communications using a CP-OFDM waveform to increase throughput and/or data rate.

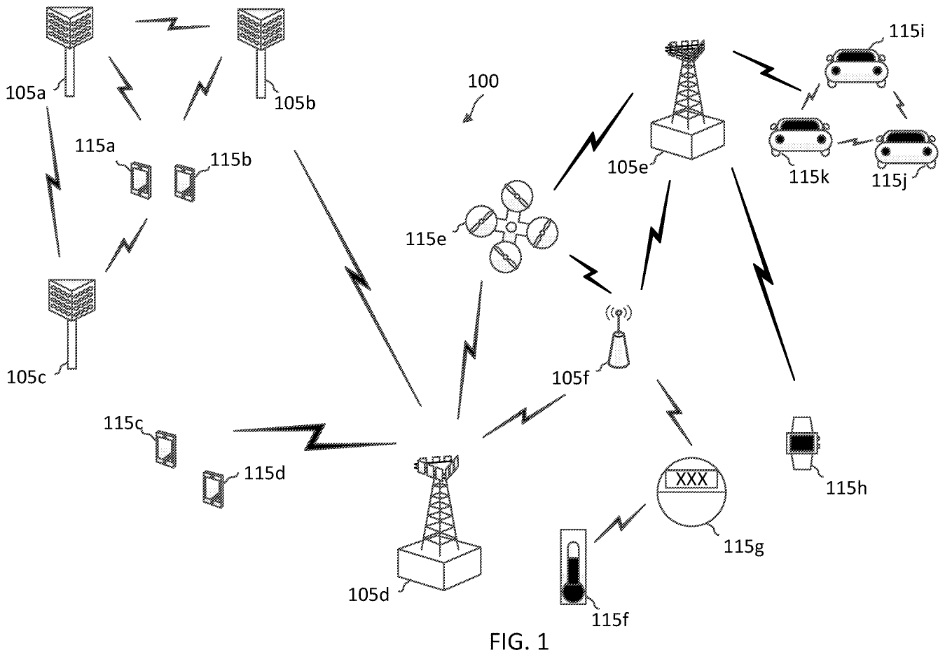

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” may refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 may assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication may be in the form of radio frames. A radio frame may be divided into a plurality of subframes, for example, about 10. Each subframe may be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes may be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal may have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe may be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 may transmit synchronization signals (e.g., including a primary synchronization signal (PSS) and a secondary synchronization signal (SSS)) in the network 100 to facilitate synchronization. The BSs 105 may broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 may perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 may enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115k may receive, from network unit 105, a configuration indicating a first absolute frequency associated with a first resource block set and a second absolute frequency associated with a second resource block set. The UE 115k may transmit, to the UE 115j, at least one of one or more first synchronization signal blocks (S-SSBs) at the first absolute frequency or one or more second S-SSBs at the second absolute frequency.

In some aspects, the UE 115k may perform a listen before talk (LBT) procedure in a first resource block set and a second resource block set based on a transmit buffer status associated with the UE 115j. The UE 115k may transmit, to the UE 115j based on the LBT being successful, a first synchronization signal block (S-SSB) in the first resource block set. The UE 115k may transmit, to the UE 115j based on the transmit buffer status associated with the UE 115k and the LBT being successful, a second S-SSB in the second resource block set.

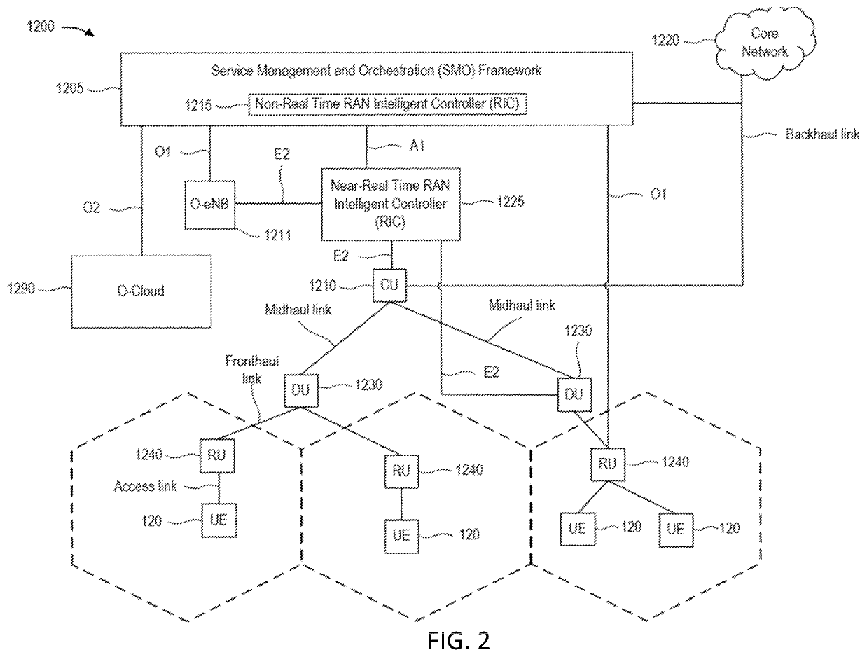

FIG. 2 shows a diagram illustrating an example disaggregated base station 200 architecture. The disaggregated base station 200 architecture may include one or more central units (CUs) 210 that may communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUS 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 may be logically split into one or more CU-UP units and one or more CU-CP units. The CU-UP unit may communicate bidirectionally with the CU-CP unit via an interface, such as the E1 interface when implemented in an O-RAN configuration. The CU 210 may be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) may be implemented with an interface configured to communicate signals with other layers (and modules) hosted by the DU 230, or with the control functions hosted by the CU 210.

Lower-layer functionality may be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 may be implemented to handle over the air (OTA) communication with one or more UEs 115. In some implementations, real-time and non-real-time aspects of control and user plane communication with the RU(s) 240 may be controlled by the corresponding DU 230. In some scenarios, this configuration may enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements may include CUs 210, DUs 230, RUs 240 and Near-RT RICs 225. In some implementations, the SMO Framework 205 may communicate with a hardware aspect of a 4G RAN, such as an open eNB (O-eNB) 211, via an O1 interface. Additionally, in some implementations, the SMO Framework 205 may communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, a first UE 115 may receive, from a network unit (e.g., the CU 210, the DU 230, or the RU 240), a configuration indicating a first absolute frequency associated with a first resource block set and a second absolute frequency associated with a second resource block set. The first UE 115 may transmit, to a second UE 115, at least one of one or more first synchronization signal blocks (S-SSBs) at the first absolute frequency or one or more second S-SSBs at the second absolute frequency.

In some aspects, a first UE 115 may perform a listen before talk (LBT) procedure in a first resource block set and a second resource block set based on a transmit buffer status associated with the first UE 115. The first UE 115 may transmit, to a second UE 115 based on the LBT being successful, a first synchronization signal block (S-SSB) in the first resource block set. The first UE 115 may transmit, to the second UE 115 based on the transmit buffer status associated with the first UE 115 and the LBT being successful, a second S-SSB in the second resource block set.

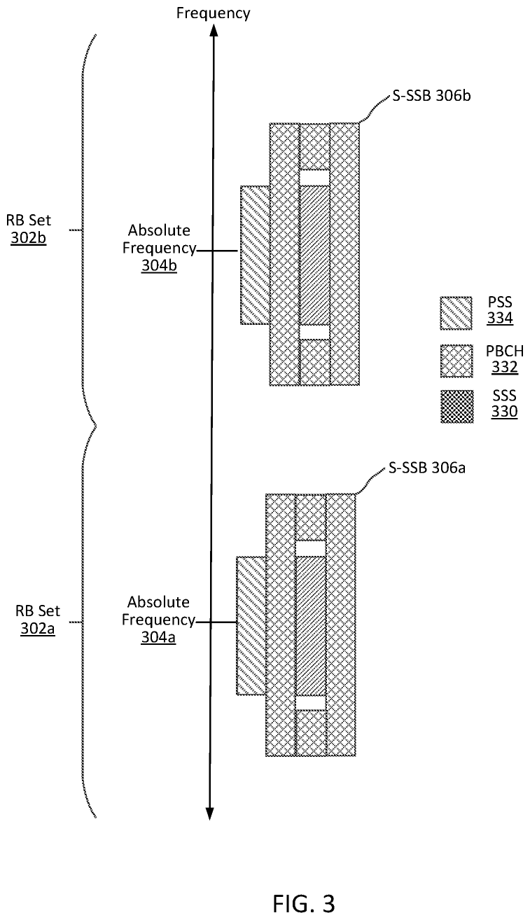

FIG. 3 illustrates S-SSB 306 resources in multiple RB sets 302 according to some aspects of the present disclosure. In some aspects, a first sidelink UE (e.g., the UE 115 or UE 700) may receive a configuration from a network unit (e.g., the network unit 105 or 800) indicating a first absolute frequency 304a associated with a first resource block (RB) set 302a. In this regard, the first sidelink UE may receive the configuration from the network unit via an RRC communication, a MAC CE communication, DCI, a PDCCH communication, a PDSCH communication, or other suitable communication. In some aspects, the configuration may further include a second absolute frequency 304b associated with a second resource block (RB) set 302b.

In some aspects, the first sidelink UE may receive the configuration from the network unit via a sl-AbsoluteFrequency S-SSBList-r16 information element. The sl-AbsoluteFrequency S-SSBList-r16 information element may indicate the first absolute frequency 304a and/or the second absolute frequency 304b. In some aspects, the sl-AbsoluteFrequency S-SSBList-r16 information element may include a list of one or more absolute frequencies 304 corresponding to each RB set 302 of a plurality of RB sets 302 (e.g., the first RB set 302a, the second RB set 302b, a third RB set, a fourth RB set, etc.). The AbsoluteFrequency S-SSBList-r16 information element may include integer values representing the absolute frequencies 304 as a number of PRBs offset from a lower end of the RB set 302.

Additionally or alternatively, the configuration indicating the first absolute frequency 304a and/or the second absolute frequency 304b may be preconfigured in a UE profile stored in the first sidelink UE.

In some aspects, the first RB set 302a may be associated with a first bandwidth part (BWP). For example, the first RB 302a set may include frequency resources spanning the first BWP. The second RB set 302b may include frequency resources spanning a second BWP. Each of the first and second RB sets 302 may include any number of resource blocks. Each resource block may include any number of frequency subchannels (e.g., 12 consecutive subchannels).

The first RB set 302a and the second RB set 302b may be used by the first sidelink UE to transmit sidelink communications to a second sidelink UE across a wide frequency band (e.g., 20 MHz, 40MHz, 80MHz, 160 MHz or more) comprising the first and second RB sets 302. The first and second RB sets 302 may be contiguous in frequency.

In some aspects, the first and second RB sets 302 may be located in a shared (e.g., unlicensed) frequency band. The shared frequency band may be located within FR1 and/or FR2 frequency bands.

In some aspects, the first absolute frequency 304a may be a frequency within the first BWP containing the first RB set 302a that is used by the first sidelink UE to transmit S-SSB 306a. In this regard, the first absolute frequency 304a may be located anywhere within the first RB set 302a, preferably within a middle portion of the first RB set 302a. For example, the first absolute frequency 304a may be located at subcarrier index 0 of resource block RB index 10 of the first RB set 302a. In some aspects, the first absolute frequency may be referred to as a sync raster. The S-SSB 306 may include a primary synchronization signal (PSS) 334, a secondary synchronization signal (SSS) 330, and/or a physical broadcast channel (PBCH) 332.

In some aspects, the second absolute frequency 304b may be a frequency within the second BWP containing the second RB set 302b that is used by the first sidelink UE to transmit S-SSB 306b. In this regard, the second absolute frequency 304b may be located anywhere within the second RB set 302b, preferably within a middle portion of the second RB set 302b. For example, the second absolute frequency 304b may be located at subcarrier index 0 of resource block RB index 10 of the second RB set 302b. In some aspects, the second absolute frequency 304b may be referred to as a sync raster. Additionally or alternatively, the first RB set 302a and the second RB set 302b may be located within the same BWP.

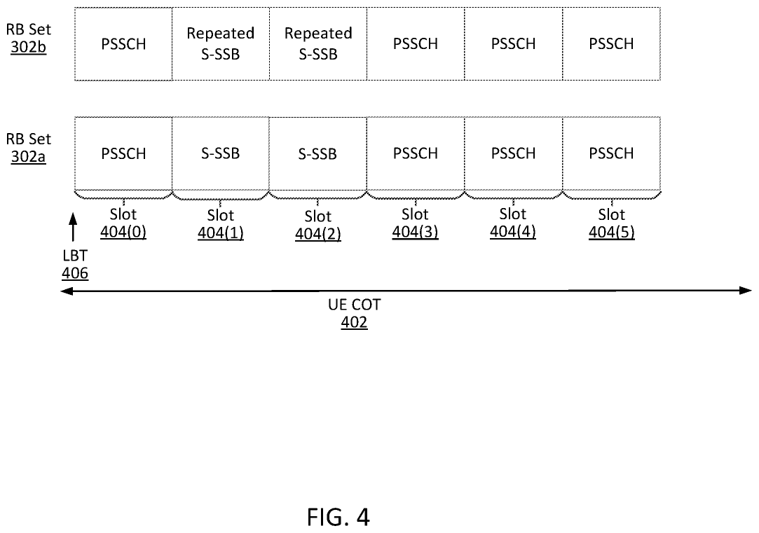

FIG. 4 illustrates first RB set 302a and second RB set 302b during a UE channel occupancy time (COT) 402 according to some aspects of the present disclosure. In some aspects, a first sidelink UE (e.g., the UE 115 or UE 700) may perform a listen before talk (LBT) 406 procedure in the first RB set 302a and the second RB set 302b. The first sidelink UE may perform the LBT 406 to gain access to a communications channel in one or more unlicensed bandwidth parts associated with the first RB set 302a and the second RB set 302b in order to transmit S-SSBs during the COT 402. The LBT 406 may be based on an LBT configuration received from the network unit. The LBT configuration may include the type of LBT 406 (e.g., a frame-based equipment (FBE)-based LBT and/or a load-based equipment (LBE)-based LBT), the category of LBT 406 (e.g., CAT2-LBT and/or CAT4-LBT), and/or at least one direction (e.g., a beam direction) associated with the LBT 406. In some aspects, the first sidelink UE may perform a single LBT 406 across both the first and second RB sets 302 and/or perform a separate LBT 406 for each of the first RB set 302a and the second RB set 302b.

In some aspects, the first sidelink UE may perform the LBT 406 procedure based on a transmit buffer status associated with the first sidelink UE. In this regard, the first sidelink UE may perform the LBT 406 procedure to gain access to both the first and second RB sets 302 across the first and second bandwidth parts based on having an amount of data in the transmit buffer that will be transmitted via PSSCHs over both the first and second RB sets 302. For example, when the amount of data in the transmit buffer satisfies a threshold (e.g., the amount of data is equal to or above the threshold), the first sidelink UE may perform the LBT 406 procedure in both the first and second RB sets 302 in order to transmit the data in both the first and second RB sets 302. In some aspects, the LBT 406 procedure may be further based on a latency budget associated with the data in the transmit buffer. For example, when the latency budget of data in the transmit buffer satisfies a threshold (e.g., the latency budget of the data is equal to or below a threshold), the first sidelink UE may perform the LBT 406 procedure in both the first and second RB sets 302 in order to transmit the data via PSSCHs in both the first and second RB sets 302 to meet the latency budget requirements.

In some aspects, the first sidelink UE may transmit a first S-SSB in the first RB set 302a to a second sidelink UE (e.g., the UE 115 or UE 700). The first sidelink UE may transmit the first S-SSB in the first RB set 302a based on the LBT 406 procedure prior to slot 404(0) being successful. In this regard, the first sidelink UE may transmit the first S-SSB in a first absolute frequency associated with the first RB set 302a. The first sidelink UE may receive an indicator from the network unit indicating the first absolute frequency as described above with respect to FIG. 3. In some aspects, the first sidelink UE may transmit the first S-SSB in slot 404(1) and repeat the transmission of the first S-SSB in slot 404(2) and/or one or more additional slots 404 (e.g., candidate S-SSB slots) in the first RB set 302a after transmitting the first S-SSB in slot 404(1). For example, the first sidelink UE may repeat the transmission of the first S-SSB in one or more candidate S-SSB slots 404 after the first slot 404(1). A candidate S-SSB slot 404 may be a slot 404 in which the first sidelink UE may optionally transmit an S-SSB.

In some aspects, the first sidelink UE may transmit a second S-SSB in the second RB set 302b to the second sidelink UE (e.g., the UE 115 or UE 700). The first sidelink UE may transmit the second S-SSB in the second RB set 302b based on the LBT 406 procedure prior to slot 404(0) being successful. In this regard, the first sidelink UE may transmit the second S-SSB in a second absolute frequency associated with the second RB set 302b. The first sidelink UE may receive an indicator from the network unit indicating the second absolute frequency as described above with respect to FIG. 3. Additionally or alternatively, the first sidelink UE may receive the indicator of the second absolute frequency from the network unit but transmit the second S-SSB in a frequency other than the second absolute frequency. In some aspects, the first sidelink UE may transmit the second S-SSB in the second RB set 302b in order to maintain the UE COT 402 and prevent another device from gaining the channel. In some aspects, the first sidelink UE may transmit the second S-SSB in the second RB set 302b in order to meet regulatory requirements such as occupied channel bandwidth (OCB).

In some aspects, the first S-SSB may comprise a first pseudorandom sequence and the second S-SSB may comprise a second pseudorandom sequence. The second pseudorandom sequence may be different from the first pseudorandom sequence. For example, the first S-SSB may comprise a BPSK modulated m-sequence whereas the second S-SSB may comprise a BPSK modulated Gold sequence or a Zadoff-Chu sequence.

In some aspects, the first sidelink UE may transmit the second S-SSB in slot 404(1) and repeat the transmission of the second S-SSB in slot 404(2) and/or one or more additional slots 404 (e.g., candidate S-SSB slots) in the second RB set 302b after transmitting the second S-SSB in the first slot 404(1). For example, the first sidelink UE may repeat the transmission of the second S-SSB in one or more candidate S-SSB slots 404 after the first slot 404(1) in the second RB set 302b. A candidate S-SSB slot 404 may be a slot in which the first sidelink UE may optionally transmit an S-SSB.

In some aspects, when the amount of data in the transmit buffer satisfies a threshold (e.g., the amount of data is equal to or above a threshold), the first sidelink UE may perform the LBT 406 procedure in both the first and second RB sets 302 in order to transmit the data in both the first and second RB sets 302. The first sidelink UE may transmit the data in a PSSCH communication to the second sidelink UE in both the first and second RB sets 302. However, when the amount of data in the transmit buffer is below the threshold, the first sidelink UE may transmit the data in a PSSCH communication to the second sidelink UE in the first RB set 302a and refrain from transmitting the data to the second sidelink UE in the second RB set 302b.

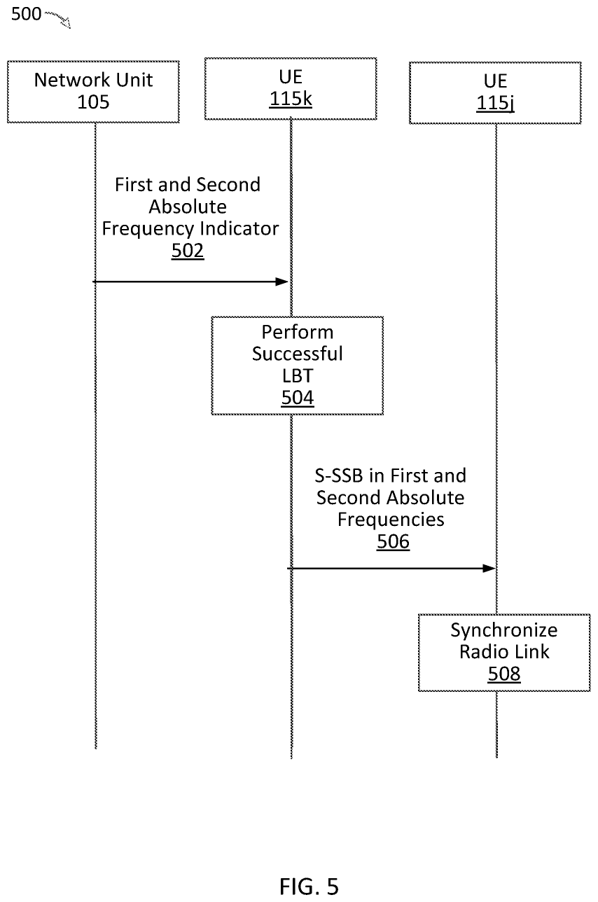

FIG. 5 is a flow diagram of a communication method 500 according to some aspects of the present disclosure. Aspects of the method 500 may be executed by a computing device (e.g., a processor, processing circuit, and/or other suitable component) of a wireless communication device or other suitable means for performing the actions. For example, a wireless communication device, such as the UE 115 or the UE 700 may utilize one or more components, such as the processor 702, the memory 704, the wideband S-SSB module 708, the transceiver 710, the modem 712, and the one or more antennas 716, to execute aspects of method 500. The method 500 may employ similar mechanisms as in the networks 100 and 200 and the aspects and actions described with respect to FIGS. 3 and 4. As illustrated, the method 500 includes a number of enumerated actions, but the method 500 may include additional actions before, after, and in between the enumerated actions. In some aspects, one or more of the enumerated actions may be omitted or performed in a different order.

At action 502, the method 500 includes the network unit 105 transmitting a configuration to UE 115k indicating a first absolute frequency associated with a first resource block (RB) set and a second absolute frequency associated with a second RB set. In this regard, the UE 115k may receive the configuration from the network unit 105 via an RRC communication, a MAC CE communication, DCI, a PDCCH communication, a PDSCH communication, or other suitable communication.

In some aspects, the UE 115k may receive the configuration from the network unit 105 via a sl-AbsoluteFrequency S-SSBList-r16 information element. The sl-AbsoluteFrequency S-SSBList-r16 information element may indicate the first absolute frequency and/or the second absolute frequency. In some aspects, the sl-AbsoluteFrequency S-SSBList-r16 information element may include a list of one or more absolute frequencies corresponding to each RB set of a plurality of RB sets (e.g., the first RB set, the second RB set, a third RB set, a fourth RB set, etc.). The AbsoluteFrequency S-SSBList-r16 information element may include integer values representing the absolute frequencies as a number of PRBs offset from a lower end of the RB set.

Additionally or alternatively, the configuration indicating the first absolute frequency and/or the second absolute frequency may be preconfigured in a UE profile stored in the UE 115k.

In some aspects, the first RB set may be associated with a first bandwidth part (BWP). For example, the first RB set may include frequency resources spanning the first BWP. The second RB set may include frequency resources spanning a second BWP. Each of the first and second RB sets may include any number of resource blocks. Each resource block may include any number of frequency subchannels (e.g., 12 consecutive subchannels).

The first RB set and the second RB set may be used by the UE 115k to transmit sidelink communications to the UE 115j across a wide frequency band (e.g., 20 MHz, 40MHz, 80MHz, 160 MHz or more) comprising the first and second RB sets. The first and second RB sets may be contiguous in frequency.

In some aspects, the first and second RB sets may be located in a shared (e.g., unlicensed) frequency band. The shared frequency band may be located within FR1 and/or FR2 frequency bands.

In some aspects, the first absolute frequency may be a frequency within the first BWP containing the first RB set that is used by the UE 115k to transmit S-SSBs. In this regard, the first absolute frequency may be located anywhere within the first RB set, preferably within a middle portion of the first RB set. For example, the first absolute frequency may be located at subcarrier index 0 of resource block RB index 10 of the first RB set. In some aspects, the first absolute frequency may be referred to as a sync raster.

In some aspects, the second absolute frequency may be a frequency within the second BWP containing the second RB set that is used by the UE 115k to transmit S-SSBs. In this regard, the second absolute frequency may be located anywhere within the second RB set, preferably within a middle portion of the second RB set. For example, the second absolute frequency may be located at subcarrier index 0 of resource block RB index 10 of the second RB set. In some aspects, the second absolute frequency may be referred to as a sync raster. Additionally or alternatively, the first RB set and the second RB set may be located within the same BWP.

At action 504, the UE 115k may perform an LBT procedure (e.g., clear channel assessment) to determine the level of interference in the resources associated with the first and second RB sets. For example, the UE 115k may measure the received energy level of transmissions from other devices. The UE 115k may measure RSSI, RSRP, SINR or other suitable measurement to perform the LBT procedure.

At action 506, the UE 115k may transmit one or more first S-SSBs and/or one or more second S-SSBs to the UE 115j. The UE 115k may transmit the one or more first S-SSBs to the UE 115j at the first absolute frequency. Additionally or alternatively, the UE 115k may transmit the one or more second S-SSBs to the UE 115j at the second absolute frequency.

In some aspects, the UE 115k may transmit the one or more first S-SSBs based on a first level of interference associated with the first RB set. In some aspects, the UE 115k may determine a first level of interference associated with the first RB set. For example, the UE 115k may measure the received energy level of transmissions from other devices. The UE 115k may measure RSSI, RSRP, SINR or other suitable measurement to perform the LBT procedure at action 504. When the measured level of interference satisfies a threshold (e.g., is less than or equal to the threshold), the UE 115k may transmit the one or more S-SSBs at the first absolute frequency.

In some aspects, the UE 115k may transmit the one or more second S-SSBs based on a second level of interference associated with the second RB set. In some aspects, the UE 115k may determine a second level of interference associated with the second RB set. When the measured level of interference satisfies an absolute threshold (e.g., is less than or equal to the threshold), the UE 115k may transmit the one or more second S-SSBs at the second absolute frequency. In some aspects, the absolute threshold may be a dBm level.

Additionally or alternatively, the UE 115k may transmit S-SSB(s) in the first RB and/or the second RB set based on the relative levels of interference in the first and second RB sets. For example, the UE 115k may transmit the one or more first S-SSBs when the level of interference in the first RB set is less than the level of interference in the second RB set. Conversely, the UE 115k may transmit the one or more second S-SSBs when the level of interference in the second RB set is less than the level of interference in the first RB set. In this manner, the UE 115k may select the RB set having the lower level of inference to transmit the S-SSBs. The UE 115k may transmit S-SSBs in both the first and second RB sets when the level of interference in both RB sets is less than a threshold.

At action 508, the UE 115j may synchronize a radio link with the UE 115k. The UE 115k may serve as a synchronization reference for the UE 115j and/or other nearby sidelink UEs and may be referred to as a SyncRef UE. The UE 115j and/or other nearby sidelink UEs that may be out of network coverage may receive S-SSB transmissions from the UE 115k and synchronize to it. Thus, the UE 115j and/or other nearby sidelink UEs can then have the same sidelink timing reference and establish sidelink communication to/from the UE 115k.

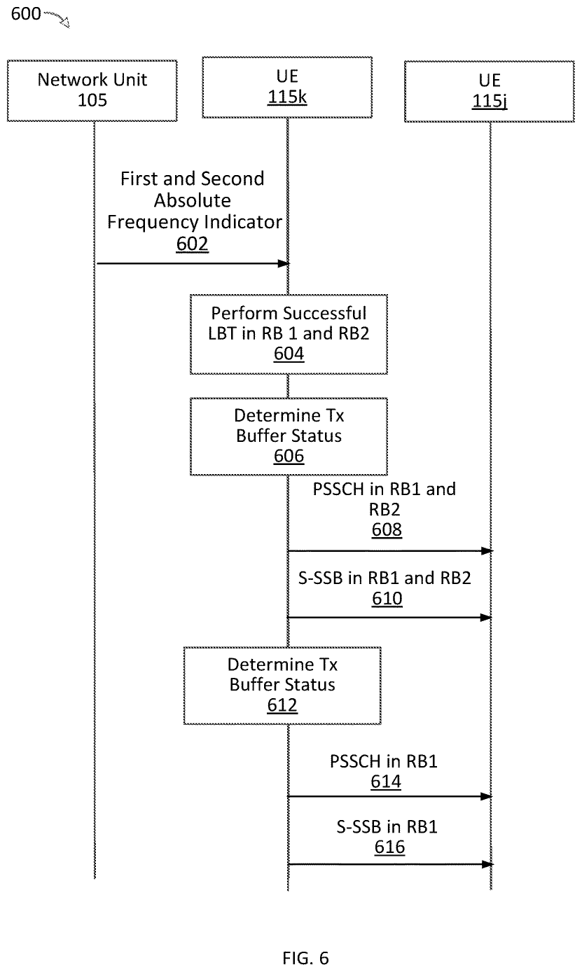

FIG. 6 is a flow diagram of a communication method 600 according to some aspects of the present disclosure. Aspects of the method 600 may be executed by a computing device (e.g., a processor, processing circuit, and/or other suitable component) of a wireless communication device or other suitable means for performing the actions. For example, a wireless communication device, such as the UE 115 or the UE 700 may utilize one or more components, such as the processor 702, the memory 704, the wideband S-SSB module 708, the transceiver 710, the modem 712, and the one or more antennas 716, to execute aspects of method 600. The method 600 may employ similar mechanisms as in the networks 100 and 200 and the aspects and actions described with respect to FIGS. 3 and 4. As illustrated, the method 600 includes a number of enumerated actions, but the method 600 may include additional actions before, after, and in between the enumerated actions. In some aspects, one or more of the enumerated actions may be omitted or performed in a different order.

At action 602, the method 600 includes network unit 105 transmitting a configuration to UE 115k indicating a first absolute frequency associated with a first resource block (RB) set and a second absolute frequency associated with a second RB set. In this regard, the UE 115k may receive the configuration from the network unit 105 via an RRC communication, a MAC CE communication, DCI, a PDCCH communication, a PDSCH communication, or other suitable communication. In some aspects, the configuration may further include a second absolute frequency associated with a second resource block (RB) set.

In some aspects, the UE 115k may receive the configuration from the network unit 105 via a sl-AbsoluteFrequency S-SSBList-r16 information element. The sl-AbsoluteFrequency S-SSBList-r16 information element may indicate the first absolute frequency and/or the second absolute frequency. In some aspects, the sl-AbsoluteFrequency S-SSBList-r16 information element may include a list of one or more absolute frequencies corresponding to each RB set of a plurality of RB sets (e.g., the first RB set, the second RB set, a third RB set, a fourth RB set, etc.). The AbsoluteFrequency S-SSBList-r16 information element may include integer values representing the absolute frequencies as a number of PRBs offset from a lower end of the RB set.

At action 604, the method 600 includes the UE 115k performing a listen before talk (LBT) procedure in a first RB set and a second RB set. The UE 115k may perform the LBT to gain access to a communications channel in one or more unlicensed bandwidth parts associated with the first RB set and the second RB set in order to transmit S-SSBs. The LBT may be based on an LBT configuration received from the network unit. The LBT configuration may include the type of LBT (e.g., a frame-based equipment (FBE)-based LBT and/or a load-based equipment (LBE)-based LBT), the category of LBT (e.g., CAT2-LBT and/or CAT4-LBT), and/or at least one direction (e.g., a beam direction) associated with the LBT. In some aspects, the UE 115k may perform a single LBT across both the first and second RB sets and/or perform a separate LBT for each of the first RB set and the second RB set.

At action 606, the method 600 includes the UE 115k determining a transmit buffer status. In some aspects, the UE 115k may perform the LBT procedure based on a transmit buffer status associated with the UE 115k. In this regard, the UE 115k may perform the LBT procedure to gain access to both the first and second RB sets across the first and second bandwidth parts based on having an amount of data in the transmit buffer that will be transmitted over both the first and second RB sets (e.g., a wideband sidelink transmission). For example, when the amount of data in the transmit buffer satisfies a threshold (e.g., the amount of data is equal to or above the threshold), the UE 115k may perform the LBT in both the first and second RB sets in order to transmit the data in both the first and second RB sets. In some aspects, the LBT procedure may be further based on a latency budget associated with the data in the transmit buffer. For example, when the latency budget of data in the transmit buffer satisfies a threshold (e.g., the latency budget of the data is equal to or below a threshold), the UE 115k may perform the LBT in both the first and second RB sets in order to transmit the data in both the first and second RB sets to meet the latency budget requirements.

At action 608, the method 600 includes the UE 115k transmitting a PSSCH in both RB set 1 and RB set 2 based on the amount of data in the transmit buffer being equal to or above the threshold.

At action 610, the method 600 includes the UE 115k transmitting a first S-SSB in the first RB set and a second S-SSB in the second RB set to the UE 115j. The UE 115k may transmit the first S-SSB in the first RB set and the second S-SSB in the second RB set based on the LBT procedure at action 606 being successful. In this regard, the UE 115k may transmit the first S-SSB in a first absolute frequency associated with the first RB set indicated at action 602. In some aspects, the UE 115k may transmit the first S-SSB in a first slot and repeat the transmission of the first S-SSB in one or more additional slots (e.g., candidate S-SSB slots) in the first RB set after transmitting the first S-SSB in the first slot. For example, the UE 115k may repeat the transmission of the first S-SSB in one or more candidate S-SSB slots after the first slot. A candidate S-SSB slot may be a slot in which the UE 115k may optionally transmit an S-SSB.

The UE 115k may transmit the second S-SSB in the second absolute frequency associated with the second RB set indicated at action 602. Additionally or alternatively, the UE 115k may receive the indicator of the second absolute frequency from the network unit but transmit the second S-SSB in a frequency other than the second absolute frequency. In some aspects, the UE 115k may transmit the second S-SSB in the second RB set in order to maintain a channel occupancy time (COT) and prevent another device from gaining the channel. In some aspects, the UE 115k may transmit the second S-SSB in the second RB set in order to meet regulatory requirements such as occupied channel bandwidth (OCB).

In some aspects, the first S-SSB may comprise a first pseudorandom sequence and the second S-SSB comprises a second pseudorandom sequence. The second pseudorandom sequence may be different from the first pseudorandom sequence. For example, the first S-SSB may comprise a BPSK modulated m-sequence whereas the second S-SSB may comprise a BPSK modulated Gold sequence or a Zadoff-Chu sequence.

In some aspects, the UE 115k may transmit the second S-SSB in a first slot and repeat the transmission of the second S-SSB in one or more additional slots (e.g., candidate S-SSB slots) in the second RB set after transmitting the second S-SSB in the first slot. For example, the UE 115k may repeat the transmission of the second S-SSB in one or more candidate S-SSB slots after the first slot in the second RB set.

At action 612, the method 600 includes the UE 115k determining a transmit buffer status. When the amount of data in the transmit buffer is below the threshold, the UE 115k may transmit the data in a PSSCH communication to the UE 115j in the first RB set and refrain from transmitting the data to the UE 115j in the second RB set. The amount of data in the transmit buffer may fall below the threshold at action 612 based on the transmission of some of the data in both RB sets at action 608.

At action 614, the method 600 includes the UE 115k transmitting data in a PSSCH communication to the UE 115j in the first RB set only and refraining from transmitting the data to the UE 115j in the second RB set based on the transmit buffer level being below the threshold.

At action 616, the method 600 includes the UE 115k transmitting an S-SSB to the UE 115j in the first RB set only and refraining from transmitting an S-SSB to the UE 115j in the second RB set based on the transmit buffer level being below the threshold.

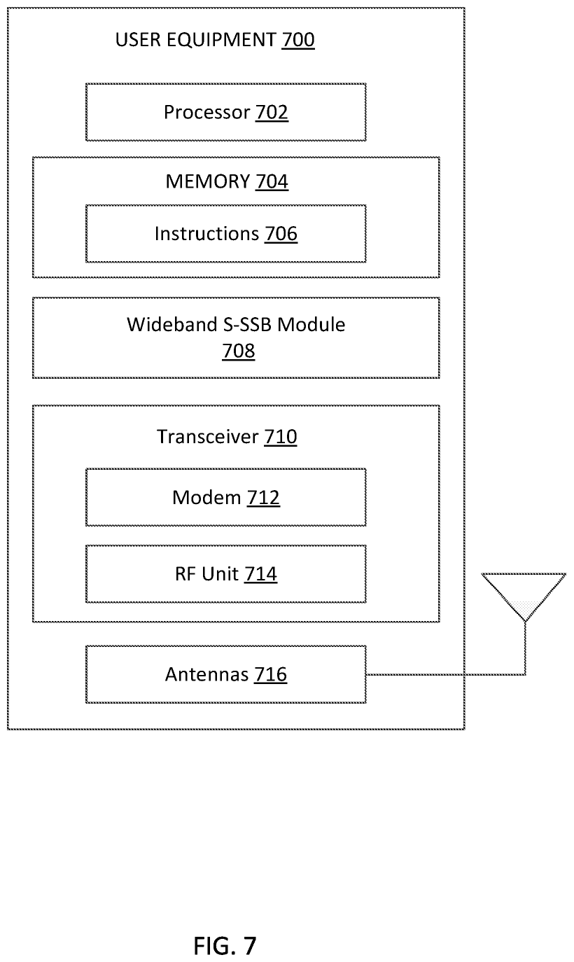

FIG. 7 is a block diagram of an exemplary UE 700 according to some aspects of the present disclosure. The UE 700 may be the UE 115 in the network 100, or 200 as discussed above. As shown, the UE 700 may include a processor 702, a memory 704, a wideband S-SSB module 708, a transceiver 710 including a modem subsystem 712 and a radio frequency (RF) unit 714, and one or more antennas 716. These elements may be coupled with each other and in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 704 includes a non-transitory computer-readable medium. The memory 704 may store instructions 706. The instructions 706 may include instructions that, when executed by the processor 702, cause the processor 702 to perform the operations described herein with reference to the UEs 115 in connection with aspects of the present disclosure, for example, aspects of FIGS. 3-6. Instructions 706 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The wideband S-SSB module 708 may be implemented via hardware, software, or combinations thereof. For example, the wideband S-SSB module 708 may be implemented as a processor, circuit, and/or instructions 706 stored in the memory 704 and executed by the processor 702. In some aspects, the wideband S-SSB module 708 may implement the aspects of FIGS. 3-6. In some aspects, the wideband S-SSB module 708 may receive, from network unit 105 or network unit 800, a configuration indicating a first absolute frequency associated with a first resource block set and a second absolute frequency associated with a second resource block set. The wideband S-SSB module 708 may transmit, to a second UE 115 or 700, at least one of one or more first synchronization signal blocks (S-SSBs) at the first absolute frequency or one or more second S-SSBs at the second absolute frequency.

In some aspects, wideband S-SSB module 708 may perform a listen before talk (LBT) procedure in a first resource block set and a second resource block set based on a transmit buffer status associated with the wideband S-SSB module 708. The wideband S-SSB module 708 may transmit, to the UE 115 or 700 based on the LBT being successful, a first synchronization signal block (S-SSB) in the first resource block set. The wideband S-SSB module 708 may transmit, to the UE 115 or 700 based on the transmit buffer status associated with the wideband S-SSB module 708 and the LBT being successful, a second S-SSB in the second resource block set.

As shown, the transceiver 710 may include the modem subsystem 712 and the RF unit 714. The transceiver 710 may be configured to communicate bi-directionally with other devices, such as the BSs 105 and/or the UEs 115. The modem subsystem 712 may be configured to modulate and/or encode the data from the memory 704 and the according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together to enable the UE 700 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The antennas 716 may include multiple antennas of similar or different designs in order to sustain multiple transmission links. The RF unit 714 may configure the antennas 716.

In some instances, the UE 700 may include multiple transceivers 710 implementing different RATs (e.g., NR and LTE). In some instances, the UE 700 may include a single transceiver 710 implementing multiple RATs (e.g., NR and LTE). In some instances, the transceiver 710 may include various components, where different combinations of components may implement RATs.

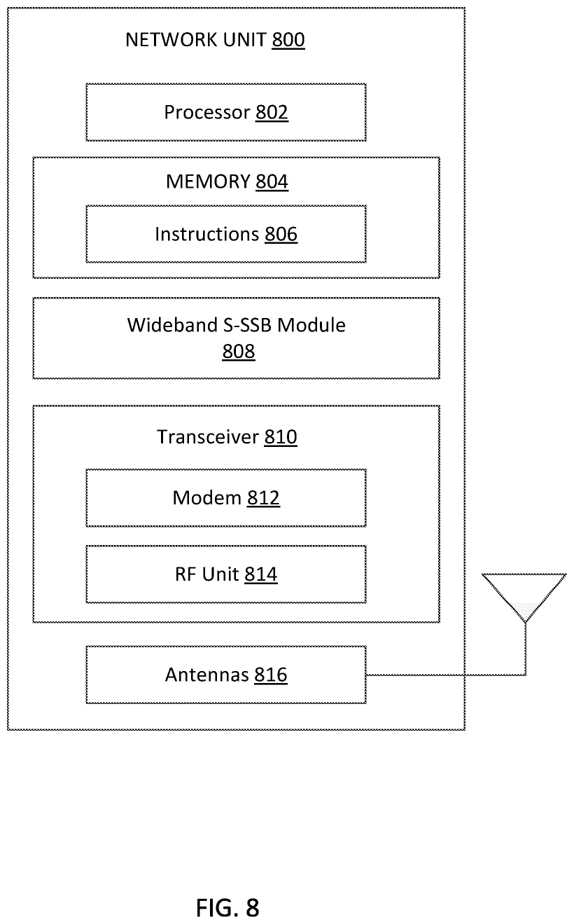

FIG. 8 is a block diagram of an exemplary network unit 800 according to some aspects of the present disclosure. The network unit 800 may be the BS 105, the CU 210, the DU 230, or the RU 240, as discussed above. As shown, the network unit 800 may include a processor 802, a memory 804, a wideband S-SSB module 808, a transceiver 810 including a modem subsystem 812 and a RF unit 814, and one or more antennas 816. These elements may be coupled with each other and in direct or indirect communication with each other, for example via one or more buses.

The processor 802 may have various features as a specific-type processor. For example, these may include a CPU, a DSP, an ASIC, a controller, a FPGA device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 804 may include a non-transitory computer-readable medium. The memory 804 may store instructions 806. The instructions 806 may include instructions that, when executed by the processor 802, cause the processor 802 to perform operations described herein, for example, aspects of FIGS. 3-6. Instructions 806 may also be referred to as code, which may be interpreted broadly to include any type of computer-readable statement(s).

The wideband S-SSB module 808 may be implemented via hardware, software, or combinations thereof. For example, the wideband S-SSB module 808 may be implemented as a processor, circuit, and/or instructions 806 stored in the memory 804 and executed by the processor 802.

In some aspects, the wideband S-SSB module 808 may implement the aspects of FIGS. 3-6. For example, the wideband S-SSB module 808 may transmit a configuration indicating a first absolute frequency associated with a first resource block set and a second absolute frequency associated with a second resource block set.

As shown, the transceiver 810 may include the modem subsystem 812 and the RF unit 814. The transceiver 810 may be configured to communicate bi-directionally with other devices, such as the UEs 115 and/or UE 700. The modem subsystem 812 may be configured to modulate and/or encode data according to a MCS, e.g., a LDPC coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or UE 700. The RF unit 814 may be further configured to perform analog beamforming in conjunction with the digital beamforming. Although shown as integrated together in transceiver 810, the modem subsystem 812 and/or the RF unit 814 may be separate devices that are coupled together at the network unit 800 to enable the network unit 800 to communicate with other devices.

The RF unit 814 may provide the modulated and/or processed data, e.g. data packets (or, more generally, data messages that may contain one or more data packets and other information), to the antennas 816 for transmission to one or more other devices. This may include, for example, a configuration indicating a plurality of sub-slots within a slot according to aspects of the present disclosure. The antennas 816 may further receive data messages transmitted from other devices and provide the received data messages for processing and/or demodulation at the transceiver 810. The antennas 816 may include multiple antennas of similar or different designs in order to sustain multiple transmission links.

In some instances, the network unit 800 may include multiple transceivers 810 implementing different RATs (e.g., NR and LTE). In some instances, the network unit 800 may include a single transceiver 810 implementing multiple RATs (e.g., NR and LTE). In some instances, the transceiver 810 may include various components, where different combinations of components may implement RATs.

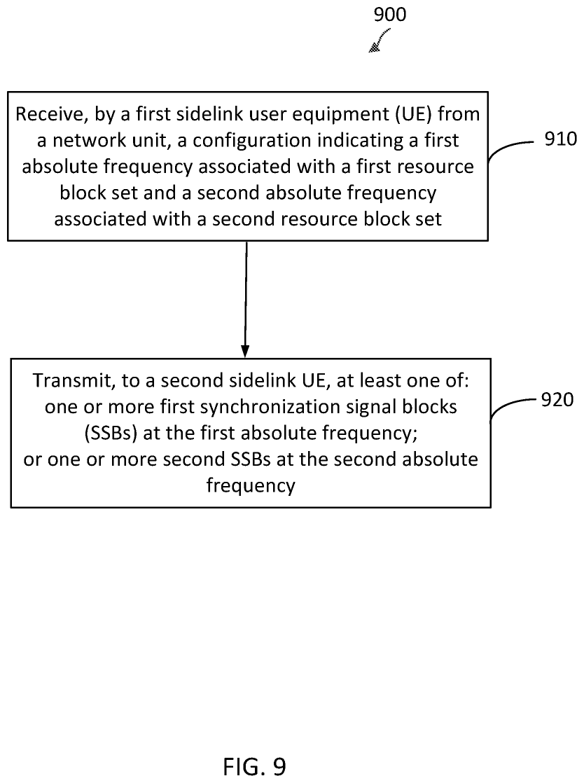

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the UE 115 or UE 700 may utilize one or more components to execute aspects of method 900. The method 900 may employ similar mechanisms as in the networks 100 and 200 and the aspects and actions described with respect to FIGS. 2-6. For example, a wireless communication device, such as the UE 115 or UE 700, may utilize one or more components, such as such as the processor 702, the memory 704, the wideband S-SSB module 708, the transceiver 710, the modem 712, and the one or more antennas 716, to execute aspects of the method 900. As illustrated, the method 900 includes a number of enumerated aspects, but the method 900 may include additional aspects before, after, and in between the enumerated aspects. In some aspects, one or more of the enumerated aspects may be omitted or performed in a different order.

At action 910, the method 900 includes a first sidelink UE (e.g., the UE 115 or UE 700) receiving a configuration from a network unit (e.g., the network unit 105 or 800) indicating a first absolute frequency associated with a first resource block (RB) set and a second absolute frequency associated with a second resource block set. In this regard, the first sidelink UE may receive the configuration from the network unit via an RRC communication, a MAC CE communication, DCI, a PDCCH communication, a PDSCH communication, or other suitable communication. In some aspects, the configuration may further include a second absolute frequency associated with a second resource block (RB) set.

In some aspects, the first sidelink UE may receive the configuration from the network unit via a sl-AbsoluteFrequency S-SSBList-r16 information element. The sl-AbsoluteFrequency S-SSBList-r16 information element may indicate the first absolute frequency and/or the second absolute frequency. In some aspects, the s-AbsoluteFrequency S-SSBList-r16 information element may include a list of one or more absolute frequencies corresponding to each RB set of a plurality of RB sets (e.g., the first RB set, the second RB set, a third RB set, a fourth RB set, etc.). The sl-AbsoluteFrequency S-SSBList-r16 information element may include integer values representing the absolute frequencies as a number of PRBs offset from a lower end of the RB set.

Additionally or alternatively, the configuration indicating the first absolute frequency and/or the second absolute frequency may be preconfigured in a UE profile stored in the first sidelink UE.

In some aspects, the first RB set may be associated with a first bandwidth part (BWP). For example, the first RB set may include frequency resources spanning the first BWP. The second RB set may include frequency resources spanning a second BWP. Each of the first and second RB sets may include any number of resource blocks. Each resource block may include any number of frequency subchannels (e.g., 12 consecutive subchannels).

The first RB set and the second RB set may be used by the first sidelink UE to transmit sidelink communications to a second sidelink UE across a wide frequency band (e.g., 20 MHz, 40Mhz, 80Mhz, 160 MHz or more) comprising the first and second RB sets. The first and second RB sets may be contiguous in frequency.

In some aspects, the first and second RB sets may be located in a shared (e.g., unlicensed) frequency band. The shared frequency band may be located within FR1 and/or FR2 frequency bands.

In some aspects, the first absolute frequency may be a frequency within the first BWP containing the first RB set that is used by the first sidelink UE to transmit S-SSBs. In this regard, the first absolute frequency may be located anywhere within the first RB set, preferably within a middle portion of the first RB set. For example, the first absolute frequency may be located at subcarrier index 0 of resource block RB index 10 of the first RB set. In some aspects, the first absolute frequency may be referred to as a sync raster.

In some aspects, the second absolute frequency may be a frequency within the second BWP containing the second RB set that is used by the first sidelink UE to transmit S-SSBs. In this regard, the second absolute frequency may be located anywhere within the second RB set, preferably within a middle portion of the second RB set. For example, the second absolute frequency may be located at subcarrier index 0 of resource block RB index 10 of the second RB set. In some aspects, the second absolute frequency may be referred to as a sync raster. Additionally or alternatively, the first RB set and the second RB set may be located within the same BWP.

At action 920, the method 900 includes the first sidelink UE transmitting one or more first S-SSBs and/or one or more second S-SSBs to a second sidelink UE. The first sidelink UE may transmit the one or more first S-SSBs to the second sidelink UE at the first absolute frequency. Additionally or alternatively, the first sidelink UE may transmit the one or more second S-SSBs to the second sidelink UE at the second absolute frequency.

The first sidelink UE may serve as a synchronization reference for the second sidelink UE and/or other nearby sidelink UEs and may be referred to as a SyncRef UE. The second sidelink UE and/or other nearby sidelink UEs that may be out of network coverage may receive S-SSB transmissions from the first sidelink UE and synchronize to it. Thus, the second sidelink UE and/or other nearby sidelink UEs can then have the same sidelink timing reference and establish sidelink communication to/from the first sidelink UE and among nearby UEs.

In some aspects, the first sidelink UE may transmit the one or more first S-SSBs based on a first level of interference associated with the first RB set. In some aspects, the first sidelink UE may determine a first level of interference associated with the first RB set. In this regard, the first sidelink UE may perform an LBT procedure (e.g., clear channel assessment) to determine the level of interference in the resources associated with the first RB set (e.g., the first BWP). For example, the first sidelink UE may measure the received energy level of transmissions from other devices. The first sidelink UE may measure RSSI, RSRP, SINR or other suitable measurement to perform the LBT procedure. When the measured level of interference satisfies a threshold (e.g., is less than or equal to the threshold), the first sidelink UE may transmit the one or more S-SSBs at the first absolute frequency.

In some aspects, the first sidelink UE may transmit the one or more second S-SSBs based on a second level of interference associated with the second RB set. In some aspects, the first sidelink UE may determine a second level of interference associated with the second RB set. In this regard, the first sidelink UE may perform an LBT procedure (e.g., clear channel assessment) to determine the level of interference in the resources associated with the second RB set (e.g., the second BWP). For example, the first sidelink UE may measure the received energy level of transmissions from other devices. The first sidelink UE may measure RSSI, RSRP, SINR or other suitable measurement to perform the LBT procedure. When the measured level of interference satisfies an absolute threshold (e.g., is less than or equal to the threshold), the first sidelink UE may transmit the one or more second S-SSBs at the second absolute frequency. In some aspects, the absolute threshold may be a dBm level.

Additionally or alternatively, the first sidelink UE may transmit S-SSB(s) in the first RB or the second RB set based on the relative levels of interference in the first and second RB sets. For example, the first sidelink UE may transmit the one or more first S-SSBs when the level of interference in the first RB set is less than the level of interference in the second RB set. Conversely, the first sidelink UE may transmit the one or more second S-SSBs when the level of interference in the second RB set is less than the level of interference in the first RB set. In this manner, the first sidelink UE may select the RB set having the lower level of inference to transmit the S-SSBs.

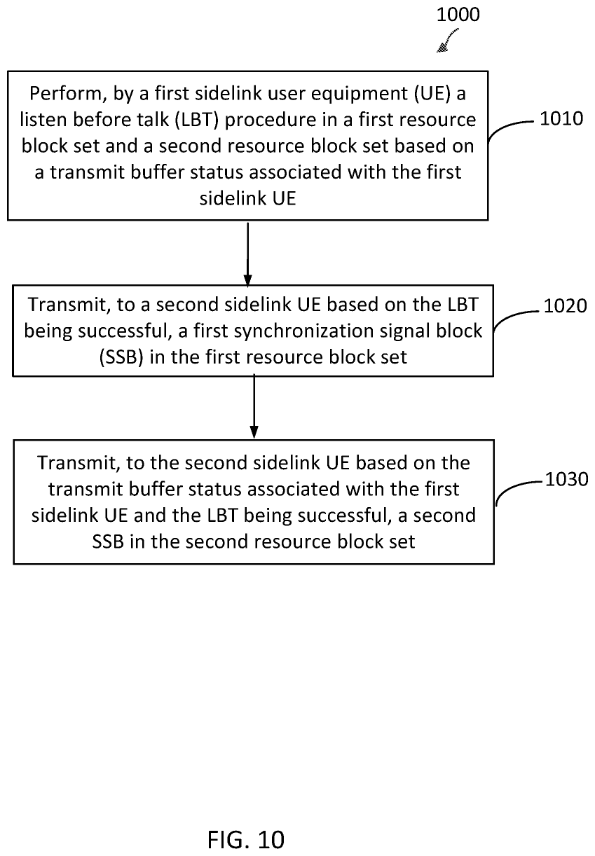

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115 or UE 700 may utilize one or more components to execute aspects of method 1000. The method 1000 may employ similar mechanisms as in the networks 100 and 200 and the aspects and actions described with respect to FIGS. 2-6. For example, a wireless communication device, such as the UE 115 or UE 700, may utilize one or more components, such as such as the processor 702, the memory 704, the wideband S-SSB module 708, the transceiver 710, the modem 712, and the one or more antennas 716, to execute aspects of the method 1000. As illustrated, the method 1000 includes a number of enumerated aspects, but the method 1000 may include additional aspects before, after, and in between the enumerated aspects. In some aspects, one or more of the enumerated aspects may be omitted or performed in a different order.

At action 1010, the method 1000 includes a first sidelink UE (e.g., the UE 115 or UE 700) performing a listen before talk (LBT) procedure in a first RB set and a second RB set. The first sidelink UE may perform the LBT to gain access to a communications channel in one or more unlicensed bandwidth parts associated with the first RB set and the second RB set in order to transmit S-SSBs. The LBT may be based on an LBT configuration received from the network unit. The LBT configuration may include the type of LBT (e.g., a frame-based equipment (FBE)-based LBT and/or a load-based equipment (LBE)-based LBT), the category of LBT (e.g., CAT2-LBT and/or CAT4-LBT), and/or at least one direction (e.g., a beam direction) associated with the LBT. In some aspects, the first sidelink UE may perform a single LBT across both the first and second RB sets and/or perform a separate LBT for each of the first RB set and the second RB set.

In some aspects, the first sidelink UE may perform the LBT procedure based on a transmit buffer status associated with the first sidelink UE. In this regard, the first sidelink UE may perform the LBT procedure to gain access to both the first and second RB sets across the first and second bandwidth parts based on having an amount of data in the transmit buffer that will be transmitted over both the first and second RB sets. For example, when the amount of data in the transmit buffer satisfies a threshold (e.g., the amount of data is equal to or above the threshold), the first sidelink UE may perform the LBT in both the first and second RB sets in order to transmit the data in both the first and second RB sets. In some aspects, the LBT procedure may be further based on a latency budget associated with the data in the transmit buffer. For example, when the latency budget of data in the transmit buffer satisfies a threshold (e.g., the latency budget of the data is equal to or below a threshold), the first sidelink UE may perform the LBT in both the first and second RB sets in order to transmit the data in both the first and second RB sets to meet the latency budget requirements.

At action 1020, the method 1000 includes the first sidelink UE transmitting a first S-SSB in the first RB set to a second sidelink UE (e.g., the UE 115 or UE 700). The first sidelink UE may transmit the first S-SSB in the first RB set based on the LBT procedure at action 1010 being successful. In this regard, the first sidelink UE may transmit the first S-SSB in a first absolute frequency associated with the first RB set. The first sidelink UE may receive an indicator from the network unit indicating the first absolute frequency as described above with respect to method 900. In some aspects, the first sidelink UE may transmit the first S-SSB in a first slot and repeat the transmission of the first S-SSB in one or more additional slots (e.g., candidate S-SSB slots) in the first RB set after transmitting the first S-SSB in the first slot. For example, the first sidelink UE may repeat the transmission of the first S-SSB in one or more candidate S-SSB slots after the first slot. A candidate S-SSB slot may be a slot in which the first sidelink UE may optionally transmit an S-SSB.

At action 1030, the method 1000 includes the first sidelink UE transmitting a second S-SSB in the second RB set to the second sidelink UE (e.g., the UE 115 or UE 700). The first sidelink UE may transmit the second S-SSB in the second RB set based on the LBT procedure at action 1010 being successful. In this regard, the first sidelink UE may transmit the second S-SSB in a second absolute frequency associated with the second RB set. The first sidelink UE may receive an indicator from the network unit indicating the second absolute frequency as described above with respect to method 900. Additionally or alternatively, the first sidelink UE may receive the indicator of the second absolute frequency from the network unit but transmit the second S-SSB in a frequency other than the second absolute frequency. In some aspects, the first sidelink UE may transmit the second S-SSB in the second RB set in order to maintain a channel occupancy time (COT) and prevent another device from gaining the channel. In some aspects, the first sidelink UE may transmit the second S-SSB in the second RB set in order to meet regulatory requirements such as occupied channel bandwidth (OCB).

In some aspects, the first S-SSB may comprise a first pseudorandom sequence and the second S-SSB comprises a second pseudorandom sequence. The second pseudorandom sequence may be different from the first pseudorandom sequence. For example, the first S-SSB may comprise a BPSK modulated m-sequence whereas the second S-SSB may comprise a BPSK modulated Gold sequence or a Zadoff-Chu sequence.

In some aspects, the first sidelink UE may transmit the second S-SSB in a first slot and repeat the transmission of the second S-SSB in one or more additional slots (e.g., candidate S-SSB slots) in the second RB set after transmitting the second S-SSB in the first slot. For example, the first sidelink UE may repeat the transmission of the second S-SSB in one or more candidate S-SSB slots after the first slot in the second RB set. A candidate S-SSB slot may be a slot in which the first sidelink UE may optionally transmit an S-SSB.

In some aspects, the first sidelink UE may perform the LBT procedure to gain access to both the first and second RB sets across the first and second bandwidth parts based on having an amount of scheduled data in the transmit buffer that will be transmitted over both the first and second RB sets. For example, when the amount of data in the transmit buffer satisfies a threshold (e.g., the amount of data is equal to or above a threshold), the first sidelink UE may perform the LBT in both the first and second RB sets in order to transmit the data in both the first and second RB sets. The first sidelink UE may transmit the data in a sidelink communication (e.g., a PSSCH) to the second sidelink UE in both the first and second RB sets. However, when the amount of data in the transmit buffer is below the threshold, the first sidelink UE may transmit the data in a sidelink communication (e.g., a PSSCH) to the second sidelink UE in the first RB set and refrain from transmitting the data to the second sidelink UE in the second RB set.

Further aspects of the present disclosure include the following:

Aspect 1 includes a method of wireless communication performed by a first sidelink user equipment (UE), the method receiving, from a network unit, a configuration indicating a first absolute frequency associated with a first resource block set and a second absolute frequency associated with a second resource block set; and transmitting, to a second sidelink UE, at least one of one or more first sidelink synchronization signal blocks (S-SSBs) at the first absolute frequency; or one or more second S-SSBs at the second absolute frequency.

Aspect 2 includes the method of aspect 1, further comprising: determining a first level of interference associated with the first resource block set; and determining a second level of interference associated with the second resource block set, wherein the transmitting the one or more first S-SSBs or the one or more second S-SSBs comprises transmitting the one or more first S-SSBs or the one or more second S-SSBs based on the first level of interference and the second level of interference.

Aspect 3 includes the method of any of aspects 1-2, wherein the transmitting the one or more first S-SSBs or the one or more second S-SSBs comprises: transmitting the one or more first S-SSBs when the first level of interference is less than the second level of interference; or transmitting the one or more second S-SSBs when the second level of interference is less than the first level of interference.

Aspect 4 includes the method of any of aspects 1-3, wherein the first resource block set and the second resource block set are located in a shared frequency band.

Aspect 5 includes the method of any of aspects 1-4, wherein the first resource block set and the second resource block set are located in a same bandwidth part (BWP).

Aspect 6 includes the method of any of aspects 1-5, wherein the receiving the configuration comprises receiving the configuration via a sl-AbsoluteFrequencySSBList-r16 message.

Aspect 7 includes the method of any of aspects 1-6, wherein the receiving the configuration comprises receiving the configuration via a radio resource control (RRC) communication.

Aspect 8 includes the method of any of aspects 1-6, wherein the first sidelink UE comprises a syncref UE.

Aspect 9 includes a method of wireless communication performed by a first sidelink user equipment (UE), the method comprising performing a listen before talk (LBT) procedure in a first resource block set and a second resource block set based on a transmit buffer status associated with the first sidelink UE; transmitting, to a second sidelink UE based on the LBT being successful, a first synchronization signal block (SSB) in the first resource block set; and transmitting, to the second sidelink UE based on the transmit buffer status associated with the first sidelink UE and the LBT being successful, a second S-SSB in the second resource block set.

Aspect 10 includes the method of aspect 9, further comprising: transmitting, to the second sidelink UE, the first S-SSB in one or more candidate SSB slots in the first resource block set; and transmitting, to the second sidelink UE, the second S-SSB in one or more candidate SSB slots in the second resource block set.

Aspect 11 includes the method of any of aspects 9-10, further comprising: transmitting, to the second sidelink UE based on the transmit buffer status satisfying a threshold, a sidelink communication via the first resource block set and the second resource block set.

Aspect 12 includes the method of any of aspects 9-11, further comprising: transmitting, to the second sidelink UE, a sidelink communication via the first resource block set; and refraining, based on the transmit buffer status satisfying a threshold, from transmitting the sidelink communication via the second resource block set.

Aspect 13 includes the method of any of aspects 9-12, further comprising receiving, from a network unit, a configuration indicating a first absolute frequency in the first resource block set, wherein the transmitting the first S-SSB comprises transmitting the first S-SSB in the first absolute frequency in the first resource block set.

Aspect 14 includes the method of any of aspects 9-13, further comprising receiving, from a network unit, a configuration indicating a second absolute frequency in the second resource block set, wherein the transmitting the second S-SSB comprises transmitting the second S-SSB in a frequency other than the second absolute frequency in the second resource block set.

Aspect 15 includes the method of any of aspects 9-14, wherein: the first S-SSB comprises a first pseudorandom sequence; the second S-SSB comprises a second pseudorandom sequence; and the second pseudorandom sequence is different from the first pseudorandom sequence.

Aspect 16 includes a non-transitory computer-readable medium storing one or more instructions for wireless communication, the one or more instructions comprising one or more instructions that, when executed by one or more processors of a sidelink UE perform any one of aspects 1-8.

Aspect 17 includes a non-transitory computer-readable medium storing one or more instructions for wireless communication, the one or more instructions comprising one or more instructions that, when executed by one or more processors of a candidate relay user equipment (UE), cause the candidate relay UE to perform any one of aspects 9-15.

Aspect 18 includes a sidelink UE comprising one or more means to perform any one or more of aspects 1-8.

Aspect 19 includes a candidate relay user equipment (UE) comprising one or more means to perform any one or more of aspects 9-15.

Aspect 20 includes a sidelink UE comprising a memory; a transceiver; and at least one processor coupled to the memory and the transceiver, wherein the UE is configured to perform any one or more of aspects 1-8.

Aspect 21 includes a candidate relay user equipment (UE)(comprising a memory; a transceiver; and at least one processor coupled to the memory and the transceiver, wherein the candidate relay UE is configured to perform any one or more of aspects 9-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations may be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first sidelink user equipment (UE), the method comprising:
receiving, from a network unit, a configuration indicating a first absolute frequency associated with a first resource block set and a second absolute frequency associated with a second resource block set; and
transmitting, to a second sidelink UE, at least one of:
one or more first sidelink synchronization signal blocks (S-SSBs) at the first absolute frequency; or
one or more second sidelink S-SSBs at the second absolute frequency.

2. The method of claim 1, further comprising:
determining a first level of interference associated with the first resource block set; and
determining a second level of interference associated with the second resource block set, wherein the transmitting the one or more first S-SSBs or the one or more second S-SSBs comprises transmitting the one or more first S-SSBs or the one or more second S-SSBs based on the first level of interference and the second level of interference.

3. The method of claim 2, wherein the transmitting the one or more first S-SSBs or the one or more second S-SSBs comprises:
transmitting the one or more first S-SSBs when the first level of interference is less than the second level of interference; or
transmitting the one or more second S-SSBs when the second level of interference is less than the first level of interference.

4. The method of claim 1, wherein the first resource block set and the second resource block set are located in a shared frequency band.

5. The method of claim 1, wherein the first resource block set and the second resource block set are located in a same bandwidth part (BWP).

6. The method of claim 1, wherein the receiving the configuration comprises receiving the configuration via a sl-AbsoluteFrequency SSBList-r16 message.

7. The method of claim 1, wherein the receiving the configuration comprises receiving the configuration via a radio resource control (RRC) communication.

8. The method of claim 1, wherein the first sidelink UE comprises a syncref UE.

9. A method of wireless communication performed by a first sidelink user equipment (UE), the method comprising:
performing a listen before talk (LBT) procedure in a first resource block set and a second resource block set based on a transmit buffer status associated with the first sidelink UE;
transmitting, to a second sidelink UE based on the LBT being successful, a first synchronization signal block (SSB) in the first resource block set; and
transmitting, to the second sidelink UE based on the transmit buffer status associated with the first sidelink UE and the LBT being successful, a second SSB in the second resource block set.

10. The method of claim 9, further comprising:
transmitting, to the second sidelink UE, the first S-SSB in one or more candidate S-SSB slots in the first resource block set; and
transmitting, to the second sidelink UE, the second S-SSB in one or more candidate S-SSB slots in the second resource block set.

11. The method of claim 9, further comprising:
transmitting, to the second sidelink UE based on the transmit buffer status satisfying a threshold, a sidelink communication via the first resource block set and the second resource block set.

12. The method of claim 9, further comprising:
transmitting, to the second sidelink UE, a sidelink communication via the first resource block set; and
refraining, based on the transmit buffer status satisfying a threshold, from transmitting the sidelink communication via the second resource block set.

13.-15. (canceled)

16. A first sidelink user equipment (UE) comprising:
a memory;
a transceiver; and
at least one processor coupled to the memory and the transceiver, wherein the first sidelink UE is configured to:
receive, from a network unit, a configuration indicating a first absolute frequency associated with a first resource block set and a second absolute frequency associated with a second resource block set; and
transmit, to a second sidelink UE, at least one of:
one or more first synchronization signal blocks (S-SSBs) at the first absolute frequency; or
one or more second S-SSBs at the second absolute frequency.

17. The first sidelink UE of claim 16, wherein the first sidelink UE is further configured to:
determine a first level of interference associated with the first resource block set;
determine a second level of interference associated with the second resource block set; and
transmit the one or more first S-SSBs or the one or more second S-SSBs based on the first level of interference and the second level of interference.

18. The first sidelink UE of claim 17, wherein the first sidelink UE is further configured to:
transmit the one or more first S-SSBs when the first level of interference is less than the second level of interference; or
transmit the one or more second S-SSBs when the second level of interference is less than the first level of interference.

19. The first sidelink UE of claim 16, wherein the first resource block set and the second resource block set are located in a shared frequency band.

20. The first sidelink UE of claim 16, wherein the first resource block set and the second resource block set are located in a same bandwidth part (BWP).

21. The first sidelink UE of claim 16, wherein the receiving the configuration comprises receiving the configuration via a sl-AbsoluteFrequency S-SSBList-r16 message.

22. The first sidelink UE of claim 16, wherein the first sidelink UE is further configured to:
receive the configuration via a radio resource control (RRC) communication.

23. The first sidelink UE of claim 16, wherein the first sidelink UE comprises a syncref UE.

24.-30. (canceled)
